(19) United States
(12) Patent Application Publication
(10) Pub. No.: US 2010/0323130 A1
(43) Pub. Date: Dec. 23, 2010

(54) ARTICLES HAVING CHROMIC INDICATORS THAT HAVE ANTIMICROBIAL PROPERTIES

(75) Inventors: Shad M. Cockman, Brown Summit, NC (US); Antonio Lombardi, Oak Ridge, NC (US); Jayson C. Linard, Alparetta, GA (US)

Correspondence Address: PASSE' INTELLECTUAL PROPERTY, LLC, 1717 BRASSFIELD RD., RALEIGH, NC, 27614, US

(73) Assignee: Healthy Grip, LLC

(21) Appl. No.: 12/720,948

(22) Filed: Mar. 10, 2010

Related U.S. Application Data
(60) Provisional application No. 61/218,548, filed on Jun. 19, 2009.

(51) Int. Cl. B44F 1/08; B44F 1/10

(52) U.S. Cl. 428/29; 427/145

(57) ABSTRACT

The present invention relates to the use of nano silver particles in a polymeric article which provides antimicrobial properties to the article. Since it has been discovered that nano silver is much more effective than colloidal silver ions, much less silver and thus, decreased cost can be achieved using the nano silver particles of the present invention.

This application claims priority of U.S. provisional application No. 61/218,548 filed on Jun. 19, 2009 and is included herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to articles which have a chromic indicator that have beneficial properties. More specifically, the present invention relates to articles which when touched indicate by thermo or chromic reaction that they have one or more of antimicrobial or biodegradable properties.

2. Description of Related Art

Antimicrobials are well known in the art and new antimicrobials are being developed regularly. Because some objects, devices and parts, thereof, are regularly handled by more than one individual, such as gas pumps, ATM machines, rest rooms, food dispensers and the like, the possibility exists of transmitting disease, microorganism or being the object of terrorism. Many people regularly wash their hands after use of any public device or object with antibacterial wipes or soaps in order to combat any risks. While this can be effective in combating a potential infection, the cost and inconvenience of rewashing the hands multiple times during the day is readily apparent. Accordingly, the inclusion of an effective antimicrobial in or on the surface of at least part of an article (such as where it is normally handled or touched) has become more common place.

Numerous types of antimicrobials are now used in the production of articles that are frequently touched by multiple individuals. Articles are typically made of polymers, metals, paper or the like but, in general, since antimicrobial coatings are possible, any manufactured article can have an antimicrobial treatment on a part or all of the exposed surface of the article. In fact, the particular material chosen may of itself have antimicrobial properties, thus negating the need to add an additional antimicrobial. For example, the antimicrobial properties of metallic ions and their colloidal forms are known. Silver and other ions have been used extensively as a disinfectant and germicide, for example, in the form of metallic silver. These compositions can be incorporated into the manufacture of articles either on the surface or incorporated into at least a portion of the article to attempt to provide antimicrobial properties. Thus, when articles are touched, any microbe is theoretically killed prior to the next person handling the article. Frequently, an article is only handled in a particular spot, for example, a gas pump handle which is only handled in one specific area. However, because one can not readily see that a device contains or is treated with an antimicrobial in or on the surface a public facility needs to either post signs indicating the device contains antimicrobial properties or use a different form of indicator or individuals will continue to be unaware of the antimicrobial condition of the particular handled object. One type of antimicrobial for inclusion in an article is disclosed in provisional application 61/167,317 entitled POLYMERIC ARTICLES HAVING ANTIMICROBIAL PROPERTIES and incorporated herein in its entirety.

Chromophors which change color based on a particular change of condition have been used now for some time. Thermochromic compositions react to heat changing from one color to another depending on the temperature of the thermochromic composition. One common example is use of thermochromic paint on coffee mugs. The empty mug has one color and when hot coffee is added, the thermochrome is heated and changes the color on the mug. Pressure chromic compositions change colors based on the application of pressure or touch to their surface.

Accordingly, it is clear that while compositions, objects and the like benefit from the use of antimicrobial or biodegradable properties, in today's society there is still an unmet need in terms of acceptance of these compositions because of the unclear presence of these compositions in any given article.

### BRIEF SUMMARY OF THE INVENTION

The present invention relates to the discovery that the inclusion of a chromic indicator in an article having antimicrobial or biodegradable properties on the surface overcomes the problems and limitations of the use of articles having such properties. Dispersing or admixing a touchchromic indicator into or on an article such that at least a portion of the surface of the article has a desired property and is made of polymer, metal, a wood product or other material allows the user to know that the article has a desired property. It accomplishes this by changing color when touched. By then promoting the combination of the color change upon touch with antimicrobials or biodegradable, individuals will become accustomed to know that when an article in commerce or privately is touched and changes color it means it has an active antimicrobial or is biodegradable in the portion where the color change occurred. Therefore, when either a thermochromic or pressurechromic composition is included in the article in the same area as the desired properties, the color change would indicate to the user that the article possessed those properties. The user would then know that the antimicrobial article used is being protected from microbes and/or could be recycled. The user would also feel more comfortable using antimicrobial treated articles that are handled by the public or recyclable material.

Accordingly, in one embodiment of the invention there is disclosed an article comprising antimicrobial properties on or in at least a portion of the surface of the article or wherein the article is a recyclable material wherein the article has incorporated a touchchromic indicator on or at the article surface.

In yet another embodiment, the invention relates to a method for producing an article having antimicrobial or recyclable material properties which indicates the presence of the antimicrobial properties on at least a portion of the surface of the article or wherein the article is a recyclable material comprising incorporating a touchchromic indicator into at least a portion of the surface of the article.

In yet another embodiment, the invention relates to a method for indicating to a user of an article that the article is made from a recyclable material or that at least a portion of the surface of the article is treated with an antimicrobial comprising:
a. assigning a particular touchchromic color to indicate the presence of the antimicrobial material, recyclable material or both;
b. manufacturing the article with the assigned touchchromic color on at least a portion of the surface of the article; and
c. informing the user of the relationship of the color to articles being made from recyclable material or having a portion of the surface comprising an antimicrobial.

### BRIEF DESCRIPTION OF THE DRAWINGS

FIG. 1 is a front view of a glass that is treated with an antimicrobial and a touchchromic indicator.

FIG. 2 is a front view of the glass of FIG. 1 which has been touched, and thus the touch is indicated by a touchchromic indication.

FIG. 3 is a front view of a bottle made of a biodegradable material of FIG. 1 having only a portion of it surface with a touchchromic indicator, which has been touched and thus the touch indicated.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures in any are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein “article” refers to an article of any kind, of whatever shape or size, whether manufactured or natural, whether a composition material or a single material. It can be a hard or soft material but in general, it refers to any object that a person would come into contact with during the normal day or commerce and touch a portion of the surface during use, whether manufactured by man or naturally occurring. It relates to objects or portions of objects that are manufactured or shaped into an article that is in or used in commerce. As noted above, articles include but are not limited to gas handles, the ATM machine, glasses and even objects such as sports equipment, rest room equipment, paper or in general any article at all that it would be desirable to have antimicrobial properties on at least a portion of the surface of the particular article. Natural objects such as plants, rocks, animals or the like could be considered articles, as well; the common element is an object that the surface will be touched by a human or animal. Further, recyclable articles such as recyclable paper, plastic, natural products can also constitute the article. In some embodiments the article could have antimicrobial properties and be recyclable as well.

As used herein “recyclable” refers to articles made from materials capable of being used in recycling process, compostable, biodegradable and the like. By selecting materials with a “green” capability the touchchromic indicators could be used to indicate the green property, for example a green touchchromic indicator.

As used herein the term “antimicrobial properties” refers to having the capability of destroying microorganisms. In one embodiment, it is an article that has an antimicrobial composition incorporated into the article itself, for example, during manufacture, by injection or the like into the article so that the antimicrobial composition is actually in the material used to make the article. The antimicrobial composition would need to be at a portion of the surface so its antimicrobial action would occur where a microorganism could be present and then be touched by an individual touching the article. In another embodiment, it is the addition of a layer of an antimicrobial composition to the surface of at least a portion of the article. This type could be used with any article that is already made or a naturally occurring article. In yet another embodiment, the material used to fabricate the article itself has antimicrobial properties itself such that a separate antimicrobial composition is not necessary to incorporate into or coat the article. In general then, articles will have antimicrobial properties at, at least some portion of the surface of the article due to the antimicrobial properties from an added antimicrobial or the antimicrobial properties of the material of the article. The inclusion of antimicrobial properties into an article to be touched is now within the skill in the art and as such, these examples are merely illustrative and a wide variety of other articles and antimicrobials can be fabricated within the art.

As used herein a “touchchromic indicator” refers to a composition which has properties which cause it to change color such as from red to clear, when it is contacted either directly or indirectly by an individual using the article. Usually after a period of time after being touched they revert to their original color so that the indicator can be constantly used. While other touchchromic indicators are possible, the most common ones are thermochromic indicators and pressurechromic indicators. A thermochromic indicator would be a composition that would change color form a change in temperature. This change in the case of touch could result from a warm hand touching an article which would trigger a color change. It could also be from a cold hand touching a warmer article.

Thermochromic colors are well known in the art. The crystalline thermochromic materials are very precise in temperature control but have limited colors available. The thermochromic dyes, and the like, offer a wider variety of colors, but are not as precise in temperature, however, they are sufficient for most needs in the present invention. They are typically colorless at one temperature and can be made to turn a particular color at a different temperature. One would then select a thermochromic color that could have the specific properties necessary to change under the conditions outlined. For example, a thermochromic dye that turned red at about 98 degrees would be useful to sense human touch.

Pressure chromic compositions are compositions which change color based on the pressure applied to the dye. Since individuals may wear gloves or ambient temperatures might be inappropriate (at 98 degrees e.g.) the use of a thermochromic indicator may be incorporated and a different type of touchchromic indicator could be used. The pressurechromic indicators could be chosen to change color when someone touches or grips an article (with a gloved hand e.g.), when an article is hit, and the like. It is clear that, in view of the disclosure of this invention, that individual touchchromic indicators can be matched to the particular article, use and conditions one finds oneself using the present invention. The use of these indicators is within the skill in the art in view of the present disclosure. Other touchchromic materials could obviously be developed or used but the principle of using them to indicate an article has been touched is the same. One could include multiple touchchromic indicators in a single article.

The antimicrobial properties, once again, are at the surface of the article of the invention. The recyclable properties would be all or part of the article. While it may only be at a portion of the surface where touching occurs, since these antimicrobials can be expensive, it can be the entire surface or a part as desired. The inclusion of the touchchromic indicator is such that it matches the surface where an antimicrobial property is. Then, with the present invention if an individual “touches” an article within the meaning herein and the article changes color where it was touched, it would be an indicator that the article was touched where antimicrobial properties are on the surface. If the surface doesn't change color or only a portion changed color it would indicate that there are no antimicrobial properties in the area touched and the individual can act accordingly. While one would need to be told initially what the chromic change indicated by standardizing the color charge to one of a limited number of colors, the change to a particular color would become recognized by the public as indicating the presence of an antimicrobial property.

The product of the present invention is made by any means known in the art in view of the disclosure herein. The incorporation of an antimicrobial or the touchchromic indication can be done separately or together. An antimicrobial and the touchchromic indicator could be mixed together in face for ease of manufacture and to insure the indicator exists anyplace the antimicrobial properties exist. The following are illustrative of many, but not all the ways of making articles of the invention. These examples will make evident how one could easily make the articles. In one embodiment, an article is manufactured by admixing an antimicrobial (with or without a carrier), the touchchromic indicator or both into the material (for example a recyclable material) used to fabricate the article. The admixing can be into the surface of the manufactured article or into an entire article made from the material. The thermochromic indicator and/or the antimicrobial could be incorporated into the surface to a selected depth of the article as well to save on cost. The precise method is not otherwise restricted and numerous methods may be used to disperse or coat both the antimicrobial and/or touchchromic indicator on an article. The best method will depend on the particular material and thermochromic indicator chosen and its particular properties, how the article is to be made or shaped and under what conditions, such as temperature and pressure, this is accomplished. One skilled in the art can balance these parameters to obtain an optimum performance in admixing, creating or coating the final article. The use of carrier molecules can aid in even distribution of the antimicrobials or thermochromic indicators as well.

The formation and cooling of a polymeric article or metal can be done by conventional means. In addition, the polymer can start out as a monomer and have the antimicrobial or thermochromic indicator added and the polymer subjected to polymerization. The article can then be subjected to molding. The best process will be chosen depending on the nature of the polymer or metal selected, the size and shape of the article and the particular use of the article containing the additive particles.

In forming an article of the invention that is itself to be later molded, carved or otherwise shaped into a separate product for sale, the article can be formed into blocks, slabs or other large shapes while other smaller sizes like rods, sheets and the like can also be formed. In addition, articles to be used in commerce can be formed as well as described above. Since the effect of the present invention is basically a surface effect, the thermochromic indicator or antimicrobial in one embodiment can be admixed such that it is essentially only incorporated into the surface of the product. In one more embodiment, the surface incorporating the thermochromic indicator is only present in the area where someone would come into contact with the article and thus, worry about achieving a bactericidal effect. Where the article is preformed, coating the article with both the touchchromic indicator and a composition with antimicrobial properties would be a method for producing these articles of the present invention.

The articles in the present invention can contain components other than just the material used to fabricate the article. For example, polymerization catalysts, stabilizers, delustering agents, optical whitening agents, pigments, fillers, plasticizers coloring agents and the like, can be added to the article. The final article may also contain liquid or other organic solvents.

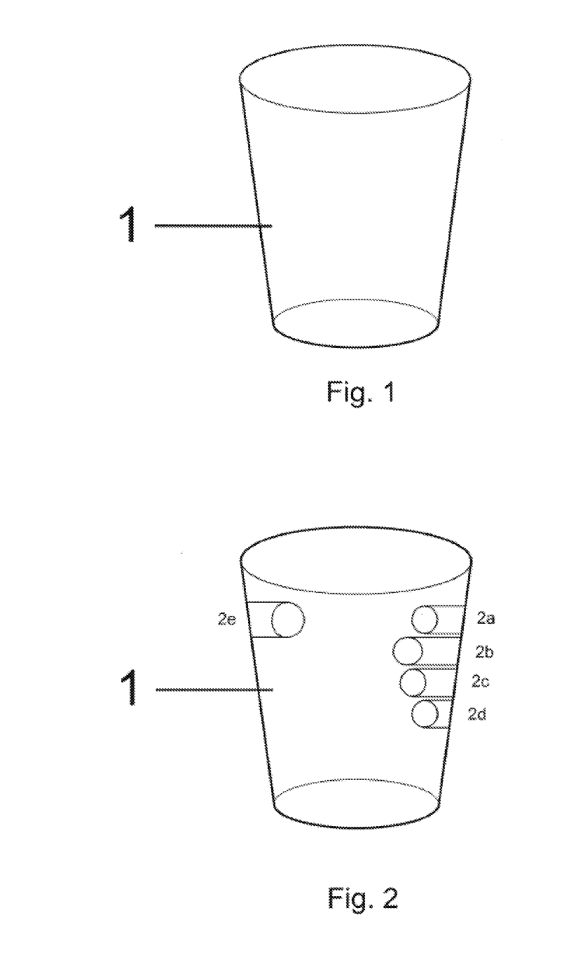

Now referring to the drawings FIG. 1 is a glass 1. This particular glass has been treated with an antimicrobial on its surface and a thermochromic material that is clear at room temperature coated on the surface. Since both are either clear or too small to see, their incorporation is not numbered. One can see if this were in a public place it would look like a regular glass.

FIG. 2 is the same glass 1 however, it has been touched by the fingers of an individual. The thermochromic indicators have turned a portion of the surface of the glass 1 a color 2a, 2b, 2c, 2d and 2e. The individual touching the glass would now know by the convention of color or experience that the glass 1 was antimicrobially treated.

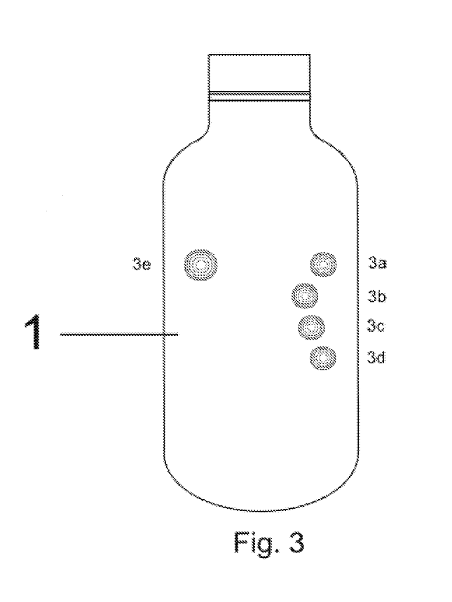

FIG. 3 is a bottle made of a recyclable material, where a portion of the surface has the antimicrobial properties and a touchchromic indicator. When touched by fingers, as in FIG. 2, a chromic color change occurs, 3a, 3b, 3c, 3d and 3e. However, the entire finger impression is not made, the fact the whole bottle is recyclable could be indicated by a specific color.

The drawings are not intended to be limiting nor intended to be inclusive of all examples. Other methods of making article sources of nano sized silver particles and the like are possible within the skill in the art. What is clear is that utilization of nano silver particles versus the colloidal particles provides a clear advantage to the user. The claims which follow should not otherwise be read as limiting the invention.

What is claimed is:

1. An article comprising antimicrobial properties on or in at least a portion of the surface of the article or wherein the article is a recyclable material wherein the article has incorporated a touchchromic indicator on or at the article surface.

2. A method according to claim 1 wherein the recyclable material is selected from the group comprising a compostable material, a biodegradable material or a material capable of being used in a recycling process.

3. An article according to claim 1 wherein the touchchromic indicator is selected from the group consisting of a thermochromic indicator or a pressurechromic indicator.

4. An article according to claim 1 wherein the article has been treated on at least a portion of the surface with a composition having antimicrobial properties.

5. An article according to claim 1 wherein the article has a composition having antimicrobial properties incorporated into at least a portion of the article.

6. An article according to claim 1 wherein the article comprises a portion of which is selected from the group consisting of polymer, metal and wood products.

7. A method for producing an article having antimicrobial or recyclable material properties which indicates the presence of the antimicrobial properties on at least a portion of the surface of the article or wherein the article is a recyclable material comprising incorporating a touchchromic indicator into at least a portion of the surface of the article.

8. A method according to claim 7 wherein the recyclable material is selected from the group comprising a compostable material, a biodegradable material or a material capable of being used in a recycling process.

9. A method according to claim 7 wherein touchchromic indicator is positioned on the surface of the article such that it is in the same position on the surface of the article as the antimicrobial properties of the article.

10. A method according to claim 7 wherein the touchchromic indicator is incorporated into the article at the surface of the article such that it is in the same position on the surface of the article as the antimicrobial properties of the article.

11. A method according to claim 7 wherein the touchchromic indicator is selected from the group consisting of a thermochromic indicator or a pressurechromic indicator.

12. A method according to claim 7 wherein the article comprises a polymer, metal, or a wood product.

13. A method for indicating to a user of an article that the article is made from a recyclable material or that at least a portion of the surface of the article is treated with an antimicrobial comprising:
a. assigning a particular touchchromic color to indicate the presence of the antimicrobial material, recyclable material or both;
b. manufacturing the article with the assigned touchchromic color on at least a portion of the surface of the article; and
c. informing the user of the relationship of the color to articles being made from recyclable material or having a portion of the surface comprising an antimicrobial.

14. A method used according to claim 13 wherein the recyclable material is selected from the group comprising a compostable material, a biodegradable material or a material capable of being used in a recycling process.
